(19) United States
(12) Patent Application Publication
(10) Pub. No.: US 2022/0133075 A1
(43) Pub. Date: May 5, 2022

(54) Accessory for Improving Operation of Espresso Coffee Brewing Machine

(71) Applicant: Mikhail Y. Bachayev, Rego Park, NY (US)

(72) Inventor: Mikhail Y. Bachayev, Rego Park, NY (US)

(21) Appl. No.: 17/090,162

(22) Filed: Nov. 5, 2020

(51) Int. Cl. A47J 31/38; A47J 31/44

(52) U.S. Cl. CPC A47J 31/38; A47J 31/4403

(57) ABSTRACT

An accessory for a conventional espresso coffee machine wherein the espresso machine has a bottom surface, and the accessory comprises a left support portion having a left support portion rear end and a left support portion forward end and a right support portion having a right support portion rear end and a right support portion forward end is disclosed. A rear joining portion joins the left support portion rear end to the right support portion rear end. The rear joining portion, the left support portion and the right support portion are configured and dimensioned to define a space between the left support portion and the right support portion. The left support portion, the right support portion and the rear joining portion together form a unitary accessory body, the accessory body have a top surface. The top surface mates with the bottom surface of the espresso machine to form a stable assembly therewith.

### CROSS REFERENCE TO RELATED APPLICATIONS

(Not applicable)

### TECHNICAL FIELD

The invention relates to an accessory and a system for improving the flavor profile of coffee made by an espresso coffee brewing machine and maintaining its temperature, by reducing the number of vessel transfers and accelerating the introduction of protective ingredients to the brew.

### STATEMENT REGARDING FEDERALLY SPONSORED RESEARCH OR DEVELOPMENT

(Not applicable)

### BACKGROUND OF THE INVENTION

Coffee may be the most widely prepared item in Western cuisine. It has been the subject of intense innovative activity, both in terms of growing, processing, roasting and brewing. Devotees of the beverage that prepare their own brew include young professionals, executives, students, blue-collar workers and seniors. Many homes and workplaces have equipment for brewing coffee. The same may range from a simple saucepan stovetop burner and a strainer to drip coffee makers, percolators, French presses, pour over devices, single-serve capsule coffeemakers, and espresso/cappuccino machines.

Baristas, amateur and professional, have scrutinized every aspect of the process, varying roasting techniques in drum, air and cast iron roasters. Grinds are adjusted, coffee distribution in the filter is leveled and care taken in the precise weight of coffee used, with typical recipes (and equipment) specifying coffee weight in the tenths of grams. Significant differences in brewed product, all other things being equal, will be experienced when the weight of the coffee used to make a double shot is varied from 15.5 grams to 17 grams.

Brewing time is also critical, with transit time of the water through the ground coffee generally agreed to produce peak flavor in 25 to 30 seconds in the case of an espresso machine, with that time measured from the first drip of the coffee from the spout of an espresso machine. Tamp pressure, which affects this (along with grind size and bean characteristic) may vary from a few ounces to thirty pounds or more. Drip coffeemakers use coarser ground coffee and have the water passing through the ground coffee for about 180 to about 240 seconds, depending on the recipe.

Home roasters will often use drum and air roasters to exercise maximized control over the roast and final brew. Typically this involves counting seconds after the “first crack” (which signals the threshold of the more common roast range) while carefully observing roast color, for example by comparing to a color standard. Where darker roasts are desired, roasting is continued to the “second crack,” after which the point in time, at which the roast is stopped, must be even more carefully controlled.

Coffee is available in a large number of varieties from various coffee producing regions, such as Columbia, the Carribean, Yemen, Ethiopia, and so forth. Sometimes the characteristics of one varietal coffee will be very different from another. Accordingly, baristas have taken to adjusting all aspects of the roasting and brewing process to the particularity variety.

As noted above, coffee comes in a variety of roasts and grind sizes. As a general rule drip coffee makers use relatively course grinds, while espresso brewing employs relatively finely ground coffee beans. The fineness of the grind will, in a gravity driven coffee brewing system, such as a poor over device or a drip coffee maker, determine the transit time of the liquid through the coffee. This combined with the size of the ground coffee will control the extraction of materials constituting flavor components from the ground coffee. If the grind is too coarse transit time will be short, penetration of boiling water into the coffee will be shallow and extraction of flavor bearing components will be low.

Conversely, if the grinds are very fine, transit time will be longer, penetration of the boiling water into the coffee will be into a greater portion of the volume of the ground coffee and extraction of flavor bearing components will be high.

The grain size of the ground coffee is not a minor matter. Machines for grinding coffee can have upwards of 200 grind size settings. In addition, the use of flat or conical burrs, as well as the selection of burr materials, such as stainless steel and ceramic, will result in ground coffee which has different flavor characteristics when brewed. In addition, because different grind sizes extract differently, coffee baristas usually prefer to have grounds which are of uniform size thus resulting in a controllable extraction and flavor profile.

Importantly, because espresso machines generally have a pump for creating the pressure to drive the brewing water through the grinds at an accelerated rate, grind size is an effective way of controlling transit time of the brewing water through the coffee grinds. Another possibility is to adjust the amount of force used to tamp the ground coffee into the portafilter, or to adjust the amount of coffee in the portafilter.

However, more is not necessarily better from the standpoint of an individual's taste. Moreover, different people have a different idea about how coffee should taste.

Even if all care is taken as discussed above, the end product can be compromised at any point in the process. In accordance with the present invention, it has been recognized that not only are the flavor profiles associated with longer extraction times different from the flavor profile of coffee produced during short extraction times, but also that the finished product results from interactions of transit time as a function of time and water volume, water temperature and the speed and extent to which extracted coffee flavors are mixed with protective components such as milk, and perhaps also, to a lesser extent, sugar. Likewise, also, the volume of water which may be added to the coffee extracted from an espresso maker also appears to affect coffee flavor over time.

One coffee maker which adds another dimension to recipe design and execution is sold under the trademark Flair. In the Flair machine, coffee is brewed in a chamber which is filled partway up with ground coffee. The bottom of the chamber comprises a filter, for example employing a conventional portafilter basket. Hot water is poured into the cylindrical upper portion of the chamber and a piston, positioned over the water, is then used to drive the water through the ground coffee, through the perforated bottom of the portafilter basket and into the cup below.

This machine is of particular interest, because it allows the barista to directly and manually vary the flow of the brewing water through the ground coffee in the portafilter basket as a function of time. For example, a barista may choose to drive only enough water through the ground coffee to wet out the ground coffee and begin the brewing process. After a period of time, if the barista is so wishes, the barista may choose to drive the water through the ground coffee quickly, after it has been brewing long enough to extract the desired flavor components which will yield the optimized flavor profile in the beverage. Generally, coffee drinkers appreciate the mix of various coffee flavor components. These include sweet components which tend to be extracted relatively quickly and are then followed by other components, which are sometimes characterized as having a sort of bitter flavor. Certain components tend to be concentrated in the creama, which may be of a relatively lipid nature and form the foam when brewing as the heated brewing water causes the release of gases contained within the particles of ground coffee in the filter basket. Some baristas use a spoon to remove excess creama.

Extracted components of coffee flavor include sugars, oils and other organic solubles with bitter, sweet and sour flavor components. These can constitute something around 15% of the total weight of the roasted coffee beans for medium roast coffees and somewhat less for dark roasted coffees. In this respect, there are not substantial differences as between roasting methods, such as air roasting (primarily used in large commercial operations and in some home roasting machines) and drum roasters which are predominantly used by boutique and craft coffee roasters.

One of the more popular coffee drinks is the so-called “cafe americano.” This drink is made by pulling a three ounce (or more for a stronger drink) espresso shot into a shot glass. One then puts about three ounces or so of hot water into the mug (preferably preheated) which the individual plans to use to drink the coffee. The espresso shot is then poured into the mug.

One variation on this recipe is for the mug to also have a quantity of milk, cream or half-and-half in it. It is believed that the lipids in milk and cream have a protective effect on molecules of flavor bearing material which interact therewith and extend the life of the beverage by slowing down chemical reactions between various coffee components.

### SUMMARY OF THE INVENTION

In accordance with the invention, it has been recognized that it may be advantageous to make a café americano by pulling an espresso shot directly into the mug from which one intends to drink, for example one which has been preheated and charged with warm water and/or an added ingredient such as milk or cream. This has the advantage of exposing the extracted shot to the protective material. However, with many espresso machines, there is not sufficient space below the portafilter or other filter to allow placement of a mug. The situation is even more of a problem with insulative travel mugs, which may be made of plastic, stainless or porcelain, or combinations of such materials because they tend to be relatively tall, often with heights of about five inches or more.

With such larger mugs, the inability of espresso machines to receive the mug and directly draw the shot into the mug results in the necessity of having to pull the shot into a shot glass and then add it to the water in the mug. Because the shot is put into two containers, it tends to cool off due to heat exchange. Likewise, shot glasses are not insulated and, accordingly, cause the espresso shot to lose additional heat. In addition, the process requires the cleaning of an additional vessel, namely the shot glass. Insofar as coffee contains oils and other materials which tend to adhere to the surface, proper cleaning requires scrubbing and soap which costs a significant amount of time, something which may be of particular importance when one is rushing, for example, heading out the door for work. In addition, it has a negative effect on the aesthetic experience of drinking a fine beverage.

While every method of making coffee has its adherents, perhaps the one which gives the best results is the Flair machine described above. However, in the case of making a drink like a café americano, while that machine does provide the possibility of a very refined control over the end product, product quality is substantially compromised by delay in dilution of the espresso shot and/or mixture with lipids in the milk. Thus, the reality is to compromise otherwise refined results in achieving a desired flavor profile because of the need to pull the shot into an intermediate vessel such as a shot glass, and then pour the espresso shot into the final drinking vessel. This added step follows from the fact that the height of the space below the spout at the bottom of the grouphead in the Flair machine is limited and cannot accommodate many desirable, especially insulated, coffee drinking vessels and cups.

As alluded to above, in addition to loss of heat, extra handling, and delay of the introduction of a protective ingredient like half-and-half, the prior art will not easily accommodate the desire of some baristas use a spoon to remove excess creama, for example, sometimes doing this on the fly. However, this is a matter of taste. In accordance with the invention, it has been recognized that even if a slightly larger coffee cup is used with many conventional espresso machines such on-the-fly adjustment of the amount of creama in the cup cannot be done at all. As a further advantage, the inventive system provides for additional space between the top of the cup and the spout at the bottom of the grouphead. This allows for removal of creama on-the-fly and incremental additional control over the brewed product.

In accordance with the invention, the above problems are addressed with a coffee making accessory. The inventive espresso making machine accessory is particularly useful for espresso machines of the type manufactured by Flair. The inventive accessory is for an espresso coffee machine, wherein the espresso coffee machine has a bottom surface, and the accessory comprises a left support portion having a left support portion rear end and a left support portion forward end and a right support portion having a right support portion rear end and a right support portion forward end. A rear joining portion joins the left support portion rear end to the right support portion rear end. The rear joining portion, the left support portion and the right support portion are configured and dimensioned to define a space between the left support portion and the right support portion. The left support portion, the right support portion and the rear joining portion together form a unitary accessory body, the accessory body having a top surface. The top surface mates with the bottom surface of the espresso machine to form a stable assembly therewith.

The unitary accessory body may have a height which ranges between 10 millimeters and 100 millimeters. In addition, multiple inventive accessories may be stacked.

The top surface may optionally be configured as a groove. The top surface may have a number of indentations for receiving feet secured to and forming a part of the bottom of the espresso coffee machine bottom surface. More particularly, it is contemplated that holes on the top surface of the inventive device will have a cylindrical configuration with a diameter of approximately 14 millimeters to easily fit the 12 mm diameter of the feet of, for example, the Flair machine.

The unitary body defines forward facing shoulder portions defined within facing portions of the left support portion forward end and the right support portion forward end, and further accommodates a tray configured to rest upon the facing forward shoulder portions.

The unitary body defines rear facing shoulder portions defined within facing portions of the left support portion rear end and the right support portion rear end, and further comprising a rear tray configured to rest upon the facing rear shoulder portions.

The unitary body may define forward facing shoulder portions defined within facing portions of the left support portion forward end and the right support portion forward end, and further may further comprise a forward tray configured to rest upon the facing forward shoulder portions.

The forward tray and the rear tray may both mate with the rear facing shoulder portions and the forward facing shoulder portions.

A substantially planar member may be secured to the bottom of the unitary body. The substantially planar member may have a relatively high coefficient of friction.

The inventive accessory may further comprise at least one abutment member mounted for movement between a first position where the abutment member is contained within the unitary body and a second position where the abutment member extends from the unitary body.

The inventive accessory may further comprise at least one abutment member mounted for movement between a first position where the abutment member is contained within the unitary body and a second position where the abutment member extends from the unitary body.

The invention provides a system for pulling espresso comprising an espresso coffee machine of the type having a manually operated piston driving a quantity of water through the ground coffee contained within a portafilter, where the espresso coffee machine includes a base with space defined between opposite sides of the base, and a lifting accessory positioned underneath the espresso coffee machine. The accessory comprises a left support portion having a left support portion rear end and a left support portion forward end and a right support portion having a right support portion rear end and a right support portion forward end. A rear joining portion joins the left support portion rear end to the right support portion rear end. The rear joining portion, the left support portion and the right support portion are configured and dimensioned to define a space between the left support portion and the right support portion. The left support portion, the right support portion and the rear joining portion together form a unitary accessory body, the accessory body have a top surface. The top surface mates with the bottom surface of the espresso machine to form a stable assembly therewith

### BRIEF DESCRIPTION OF THE DRAWINGS

The operation of the inventive espresso making machine accessory will become apparent from the following description taken in conjunction with the drawings, in which:

FIG. 1 is a perspective view generally illustrating an implementation of the present invention in association with a prior art espresso making machine;

FIG. 2 is a diagrammatic cross-sectional representation of a prior art espresso making machine of the type which is manually pumped to pull a shot from ground coffee;

FIGS. 3 through 8 are diagrammatic cross-sectional representations of the inventive accessory positioned underneath a prior art espresso making machine and illustrating the use of the accessory of the present invention in the context of making a café americano;

FIG. 9 is a simplified side elevational cross-sectional view of an alternative embodiment of inventive accessory incorporating a single tray and constructed in accordance with the present invention;

FIG. 10 is a top plan view of the inventive accessory along lines 10-10 of FIG. 9;

FIG. 11 is a cross-sectional view along lines 11-11 of FIG. 10 and illustrating the operation of the tray supporting shoulder or ledge in the inventive coffee machine accessory;

FIG. 12 is a view similar to that of FIG. 11 of an alternative embodiment of the invention in which support feet are replaced by a flat planar rubber member which is glued to the bottom of the main body of the inventive accessory;

FIG. 13 is a detailed view of a portion of an alternative embodiment of the invention in which spring-loaded braces are provided to increase the stability of the inventive assembly of espresso machine and accessory when an espresso shot is being manually pulled;

FIG. 14 is a perspective view of another embodiment of the inventive accessory illustrating the bottom of the accessory and the use of rotating pegs to provide a brace against a work surface to increase the stability of the inventive assembly of espresso machine and accessory when an espresso shot is being manually pulled;

FIG. 15 is a diagrammatic representation in cross-section of the operation of the rotating peg embodiment illustrated in FIG. 14;

FIG. 16 illustrates an alternative embodiment of an espresso machine accessory featuring extra height and a second tray shoulder to accommodate small cups; and

FIG. 17 illustrates yet another alternative embodiment of an espresso machine accessory featuring an alternative engagement structure for the espresso machine;

FIG. 18 is a view similar to that of FIG. 10, in which the inner diameter of the inventive accessory 514 is considerably smaller in length and breadth to accommodate easy placement of a tray without wedging or sliding it into places; and

FIG. 19 is a top plan view of another alternative embodiment of the invention.

### DETAILED DESCRIPTION OF THE PREFERRED EMBODIMENTS

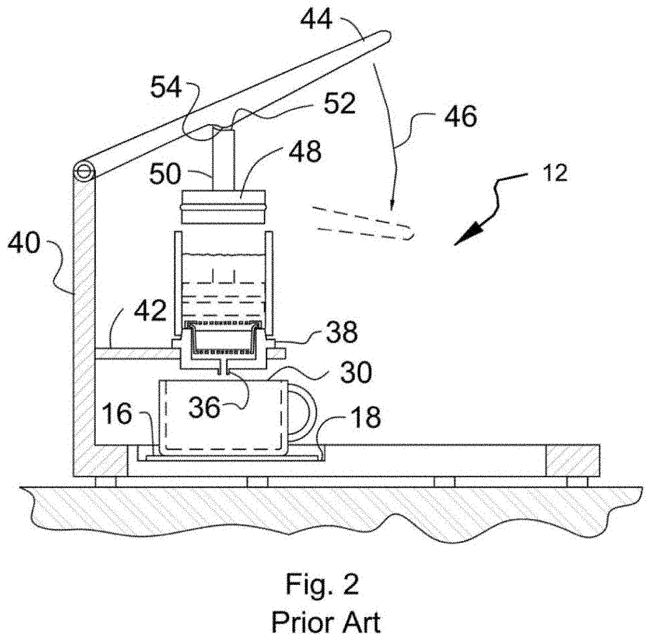

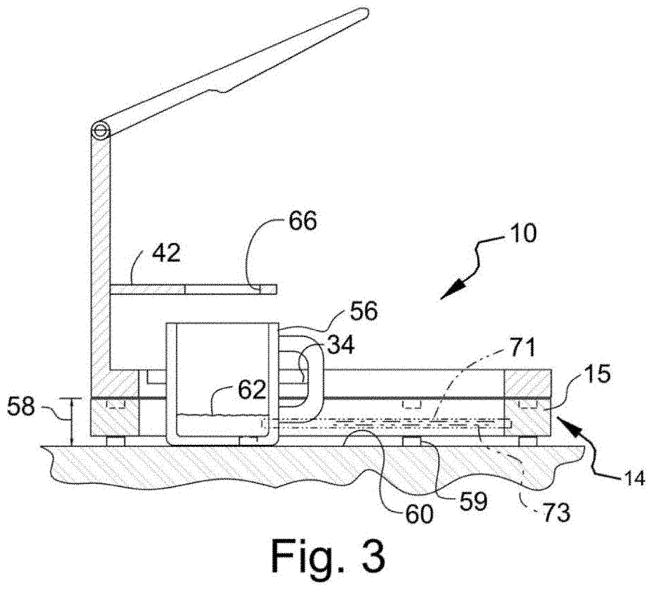

The inventive system 10 comprises a conventional espresso machine with limited space under the grouphead, such as a manually operated piston and cylinder espresso machine 12, for example of the type available on the market under the trademark Flair, and the inventive accessory 14. Inventive accessory 14 comprises a main body 15 (FIG. 3) which may be made of water, injection molded plastic, metal, or any other suitable structural material. Main body 15 may be made to be solid or hollow. It is noted that while the invention is illustrated in connection with the Flair espresso machine, the invention may be applied to any espresso machine which has the grouphead positioned directly over the work surface on which the machine sits without any intervening structure, or machines, such as the Flair where the intervening structure may be removed to expose the top of the work surface. In the case of the Flair machine, that intervening structure is a tray 16 (FIG. 2) which sits on a shoulder 18 in the base 20 of the espresso machine.

The inventive system includes structure for mating with the base 20 of the espresso machine. For example, if espresso machine 12 has rubber feet, holes 21 may be put in the top surface of the inventive accessory 14 which mate with and receive the rubber feet on the Flair. Alternatively, the top surface of the inventive accessory may be provided with an indentation which mates with the bottom of the espresso machine.

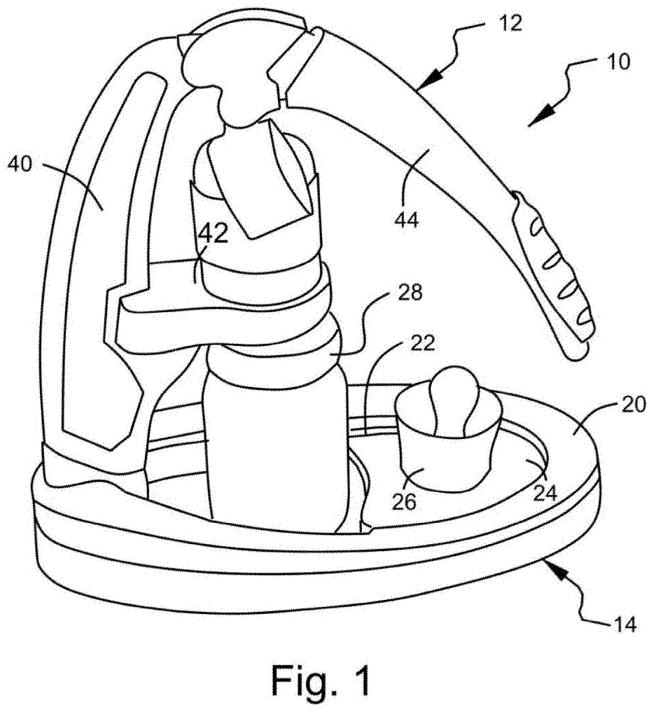

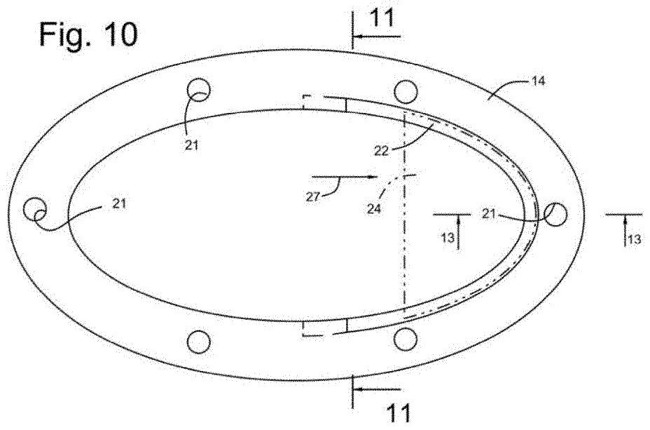

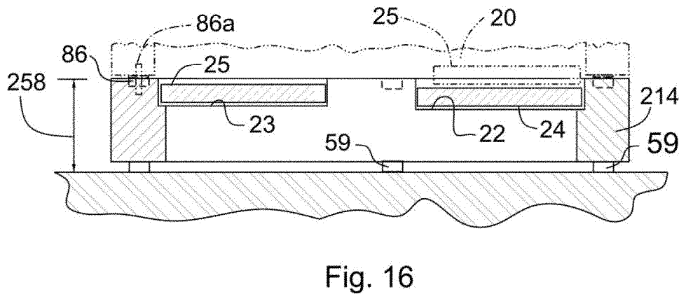

Referring back to FIG. 1, the inventive accessory 10 may optionally be provided with a ledge or shoulder 22 for receiving a tray 24, where coffee making tools such as a tamper 26 may be positioned. Optionally, a second shoulder 23 may be provided for supporting a second tray 25, as illustrated in FIG. 16. Trays should be dimensioned to be small enough to be angled into the gap between the shoulder and the bottom of the conventional espresso machine, and then dropped into the other side of the shelf. Alternatively, the shelf can be extended as illustrated in dashed lines in FIG. 10 to a point where angling the shelf into position is unnecessary and the shelf can be dropped in and slid in the direction of arrow 27.

As compared to a conventional manually controlled compression espresso machine such as the Flair machine, as can be seen in FIG. 1, the inventive system can accommodate a relatively tall coffee receiving vessel, even one as large as a medium-size mayonnaise jar 28. This compares with the relatively limited options without inventive accessory 14. More particularly, as illustrated in FIG. 2, which illustrates a conventional Flair coffee machine resting on a counter or table top, such prior art machines can only accommodate a relatively short cappuccino or espresso cup 30. In this embodiment, cup 30 rests on a support platform for tray 16 which seats in a ledge or shoulder 18 in the base 20 of conventional espresso machine 12.

More particularly, the space between the portafilter spout 36 on portafilter 38 and tray 24 is limited, leaving just enough space for a short cup or other drinking vessel. Portafilter 38 sits within horizontal support 40 attached to the vertical support 42 of the conventional espresso machine 12. Generally, conventional machine 12 is operated by grasping handle 44 and moving it from the position shown in solid lines in FIG. 2 in the direction of arrow 46 until it reaches the position illustrated in dashed lines in FIG. 2. This results in advancing the piston 48 from the position shown in solid lines to the position shown in dashed lines. This is achieved by providing piston 48 with a rigidly mounted drive bar 50 having a cam surface 52 which mates with cam surface 54 on handle 44. In this manner piston 48 is driven downwardly, advancing it to the position shown in dashed lines in FIG. 2.

In contrast to the limited space provided by a conventional espresso machine 12 which is not outfitted with the inventive accessory 14, when conventional espresso machine 12 is fitted with inventive accessory 14, additional space is provided between portafilter spout 36 on porta filter 38 and the countertop, as illustrated in FIG. 3. This enables the positioning of a large cup or mug 56 underneath horizontal support 42. The same is enabled by providing accessory 14 with a height 58 sufficient to accommodate the additional height of taller mugs, cups and other vessels.

Part of the height of the inventive accessory 14 is provided by a plurality of feet 59 which are secured to the bottom of accessory 14. In a preferred embodiment of the invention.

In accordance with the invention, height 58 should be greater than a half centimeter, and preferably greater than 1.7 cm, which will accommodate the greater percentage of mugs on the market. Most preferably, however, height 58 should be greater than 23 mm, and a most preferable range between 23 mm and 40 mm. More particularly, when the height 58 is 40 in height, this creates a clearance 61 between the bottom of portafilter spout 36 and the tabletop 60 of approximately 130 mm. In accordance with the invention, this dimension may be varied, for example ranging between 110 mm and 155 mm, and preferably between 115 and 145 mm. with the currently commercially available models of the Flair coffee maker on the market. The result is a wide range of cups, travel mugs, mugs and the like which fit within this clearance may be readily found on the market in a variety of styles and with a variety of functionalities, such as vacuum insulation, large handles, and so forth. Optionally, mug 56 may be preheated to prevent cooling of the espresso shot after exiting portafilter spout 36.

In accordance with the invention, it is contemplated that several lifting inventive accessories having different heights may be packaged together as a kit allowing selective use of the same by the barista.

As alluded to above, in accordance with the invention, the mug may be charged with a quantity of liquid ingredient 62, such as preheated milk, water or cream. A wide range of possibilities and volumes may be accommodated because of the large size of the mugs which can be accommodated by the inventive espresso machine and accessory system. The extra space provided by the inventive system enables the introduction of, for example, about 3 ounces or so of hot water (or more for a larger drink) into the mug from which the individual plans to drink the coffee. When the inventive system, the espresso shot directly falls from spout 36 into the mug (FIG. 3). There is thus no need for an intermediate shot glass with extra cleaning and pouring and undesirable cooling of the espresso shot, and also delaying the protective action of other ingredients such as half-and-half, which are pre-charged into the mug before drawing the shot of espresso.

The inventive device also provides other flexibilities to the barista. For example, double shot, triple shot and larger beverages are easily accommodated in the larger cups, even in the case of drinks incorporating substantial amounts of additional ingredients, such as a café americano.

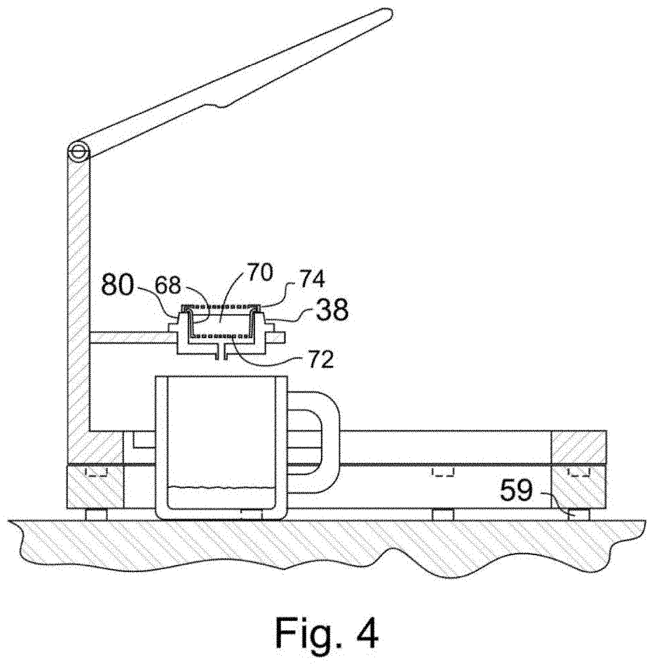

The brewing of the beverage in accordance with the method of the present invention using the inventive system 10 may be understood with reference to FIGS. 3-8. More particularly, as illustrated in FIG. 3, a mug, for example, with optional additional ingredients such as boiling water 62, is placed underneath horizontal support 42. As shown in FIG. 4, a portafilter 38 is placed within orifice 66 in horizontal support 42. Portafilter 38 receives a conventional filter basket 68, which may be charged with ground coffee 70. The bottom 72 of filter basket 68 is perforated which causes it to function as a coffee filter. The top of filter basket 68 is covered by a second filter 74 as illustrated in FIG. 4.

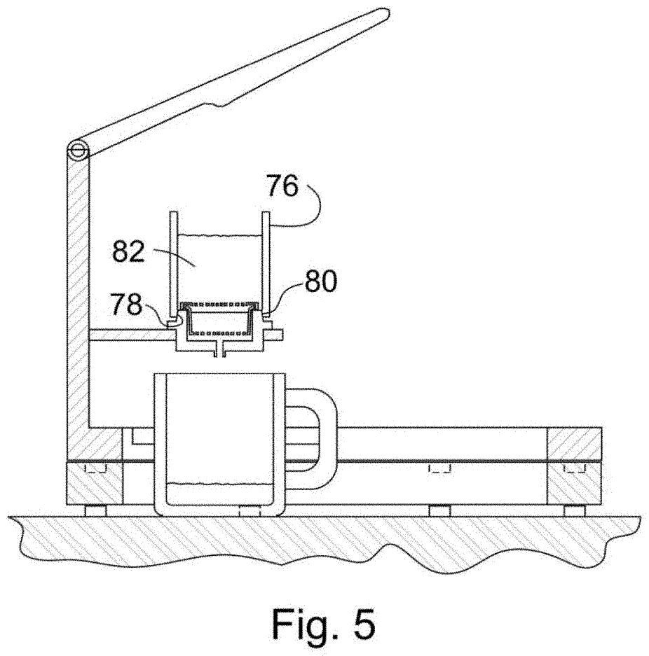

Next, as is illustrated in FIG. 5, a grouphead cylinder 76 is positioned around the periphery 80 of portafilter 38. The lower inside circumference 78 of grouphead cylinder 76 mates with and seals against the outer periphery 80 of portafilter 38. Optionally, grouphead cylinder 76 may be preheated, for example by submersing in boiling water. Once grouphead cylinder 76 is positioned and sealed against portafilter 38, boiling water 82 is introduced into grouphead cylinder 76.

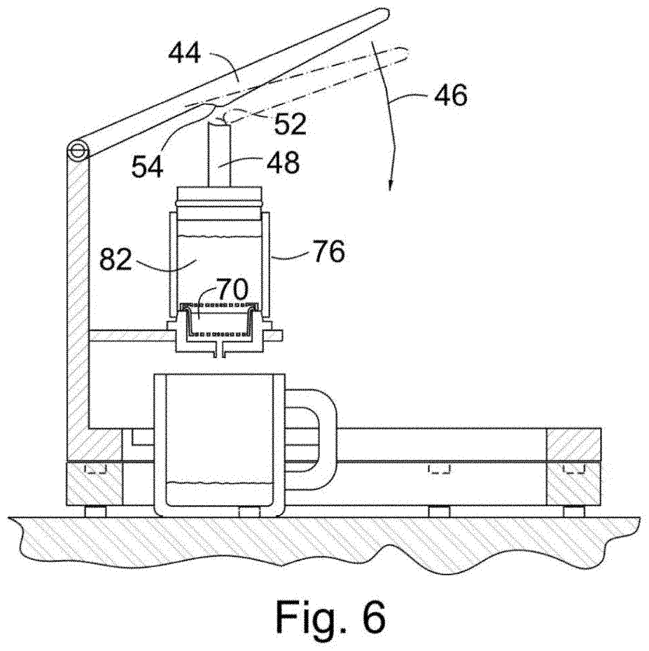

Referring to FIG. 6, piston 48 is positioned as illustrated, partially inside grouphead cylinder 76. Handle 44 is then moved in the direction of arrow 46 from the position illustrated in solid lines in FIG. 6 to the position illustrated in dashed lines, resulting in bringing cam surface 52 into contact with cooperating cam surface 54 on handle 44. Further movement of handle 44 in the direction of arrow 46 results in advancing piston 48 downwardly to force the brewing water 82 through ground coffee 70.

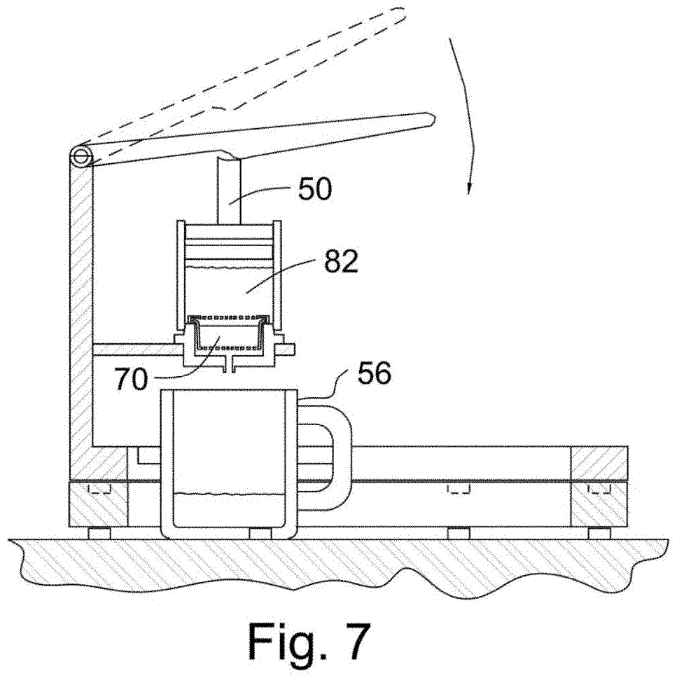

After the initial contact between cam surface 52 on drive bar 50 with cooperating cam surface 54 on handle 44, continued movement advances piston 48 to the position illustrated in FIG. 7. When piston 48 reaches the position illustrated in FIG. 7, a substantial amount of the brewing water 82 has been driven through the ground coffee 70 and into mug 56.

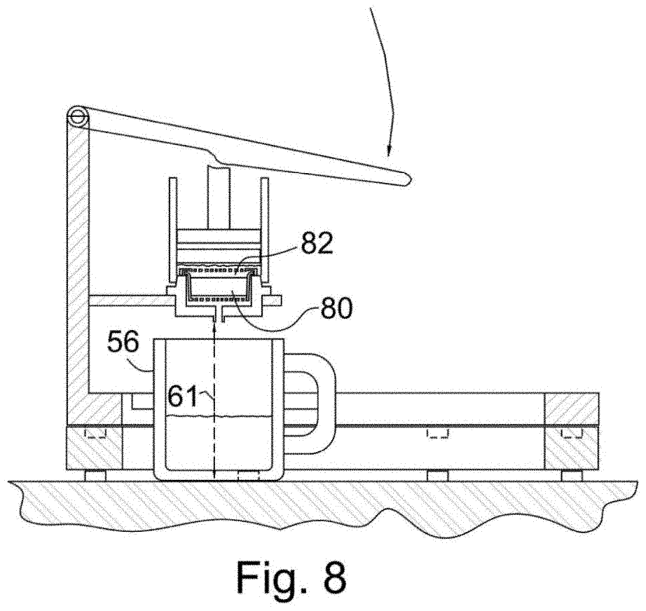

Continued advancement of the handle brings the inventive system 10 to the position illustrated in FIG. 8, where the brewing has been completed and almost all of the brewing water 82 has passed through the now spent coffee grounds 80 and into mug 56.

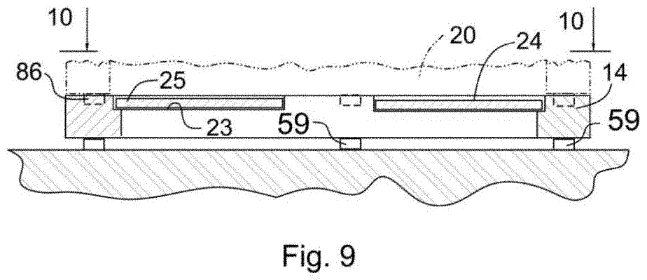

The interconnection between the base 20 of conventional espresso machine 12 and the inventive accessory 14 may be seen in FIG. 9. More particularly, underneath and secured to the base 20 are a number of rubber feet 86 which are received within holes 21 in the inventive accessory 14 (FIG. 10). The footprint of inventive accessory 14 is configured and dimensioned to match, from the standpoint of support, the footprint of the base of the coffee maker which it supports. In the illustrated example of the invention, inventive accessory 14 has a roughly elliptical shape. In addition, it incorporates shoulder 22 for supporting tray 24, as illustrated in FIGS. 10 and 11. With respect to the placement of the tray in the machine, where the tray is not permanently attached, a slot 63 (FIG. 11) passing from the outside of the inventive accessory and leading to the ledge for supporting the tray may be provided. This allows the tray to be inserted in place from the side of the inventive accessory through the slot. In accordance with the invention the tray provided with the Flair machine may be used in this manner. Insofar as significant force is applied to espresso machine 12 during use, it is important that the inventive accessory 14 not slide on the table or other work surface, on which it is resting during use. Accordingly, accessory 14 is provided with a plurality of rubber feet 59.

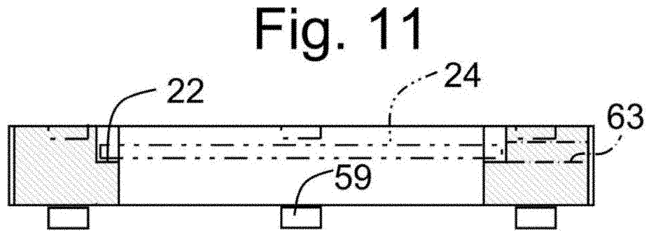

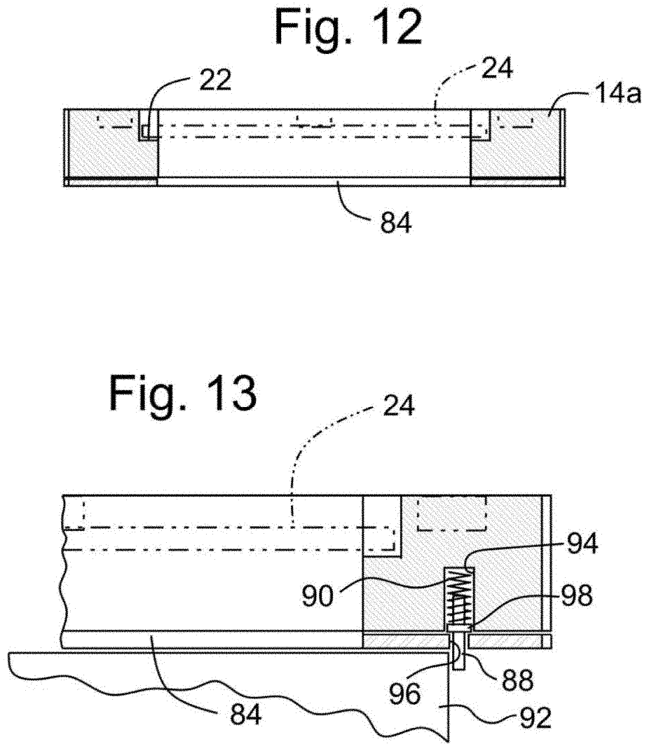

As an alternative to feet 59, a single flat rubber member 84 may be provided, as illustrated in FIG. 12. The flat rubber member 84 may be made of any suitable high friction material, and is glued to the bottom of the main body portion 14a of the inventive accessory. Optionally, a bar 88 (or, optionally, a pair of spring-loaded bars) may be recessed and spring-loaded within accessory 14, as illustrated in FIG. 13. When the bars are desired to be used, the accessory is lifted allowing spring 90 to drive bar 88 down. Accessory 14 is then placed on the table 60 with bar 88 bearing against the side 92 of table 60, giving the system added stability. When it is not desired to use the stabilizing bar 88, simply putting accessory 14 onto the counter and allowing it to rest on the countertop results in bar 88 being driven again spring 90 into cylindrical hole 94. The assembly of bar 88 and spring 90 is retained in hole 94 by flat rubber member 84 through the action of hole 96 which is larger in diameter than bar 88 but smaller in diameter than shoulder 98 on bar 88.

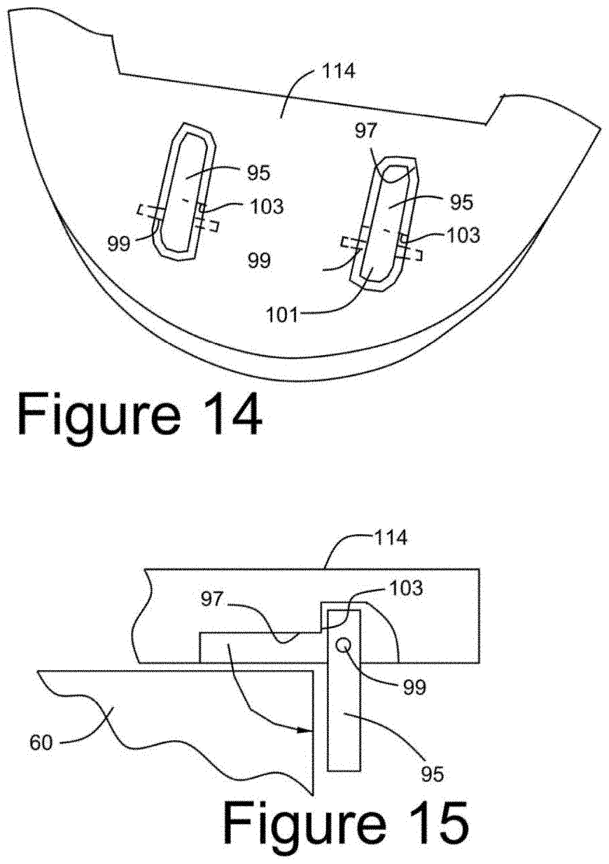

Alternatively, stability against the edge of the tabletop may be achieved by using a pair of rotatably mounted pegs 95, which sit within recesses 97 and rotate on axles 99, as illustrated in FIG. 14. In this case, the front of the inventive accessory 14 is provided with a solid front to provide space for recesses 97. When it is desired to use pegs 95, they are simply rotated outside of accessory 114 and allowed to hang vertically over the edge of the table against which edge they are caused to bear prior to the application of force to the handle 44 of the inventive accessory 14, with short end 101 bearing against wall 103 in recess 95.

A taller version of the inventive accessory 214 is illustrated in FIG. 16. In this embodiment, height 258 is approximately 40 mm. Of course, this dimension is not critical and may range, for example, between 20 mm and 70 mm, preferably between 30 mm and 65 mm and most preferably in a range between 32 mm and 48 mm. Also in accordance with the present invention an additional lifting member may be provided. For example, the inventive first member may range in size between 30 mm and 50 mm in height and the additional inventive lifting member may range between 10 mm and 20 mm in height. Yet another alternative is to have a second shoulder 23 provided for supporting a second tray 25. Tray 25 is of particular use if the cup being used is relatively small, such as a demitasse or espresso cup. The extra tray is of particular value with such small cups which might be difficult to access resting on the tabletop.

Optionally, tray 25 may be shaped and dimensioned to allow it to be flipped over and stored above tray 24, as illustrated in phantom lines in FIG. 16. This allows tray 24 to be easily taken from the storage position and used whenever necessary. Optionally, tray 24 may be larger than tray 25, or they may be the same size. This gives the user the option of placing the larger tray 24 on top of tray 25 (positions opposite those illustrated in FIG. 16) which makes removal of the top tray 24 easier. Such a two tray variation may be used in all of the embodiments of the invention illustrated herein.

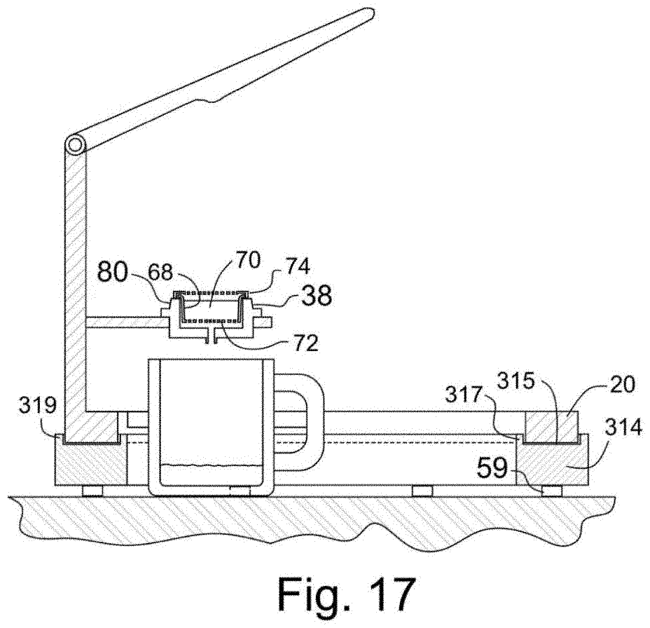

Another embodiment of the inventive accessory is illustrated in FIG. 17. This alternative embodiment of inventive accessory 314 comprises a top surface with a trough or groove 315, within which base 20 of the conventional espresso machine rests, as illustrated. Groove 315 is defined between raised inner wall 317 and outer wall 319. The result is a stable mating structure which raises the conventional espresso machine and allows the use of a larger cup or mug.

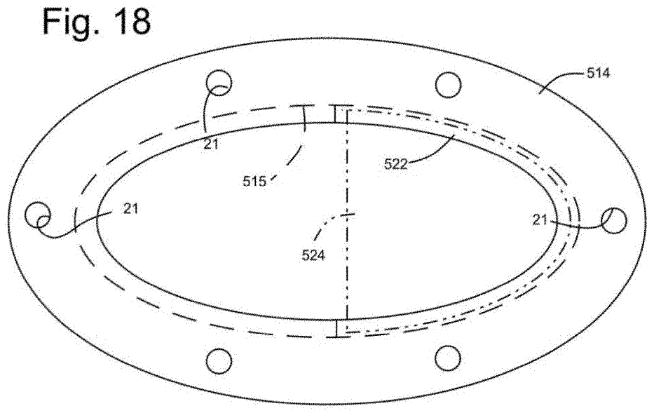

Referring to FIG. 18, yet another alternative embodiment of the present invention is illustrated. In this embodiment, the inner dimensions of the inventive accessory 514 are considerably smaller in length and breadth than the inner circumference 515 of the conventional coffee machine (illustrated in dashed lines in FIG. 18), which is resting on it. This enables the use of shoulder 522 which is not blocked by the conventional coffee machine when the conventional coffee machine is in place. This accommodates the easy placement of tray 524 without wedging or sliding.

Still yet another alternative for the structure of the present invention is illustrated in phantom lines in FIG. 3. In accordance with this embodiment, a slot passageway 71 is provided at the storage side of the inventive accessory 14 for receiving a tray 73. In particular, it is noted that the size of the slot passageway is substantially longer than the length of tray 73. This is to accommodate the insertion of the tray provided with the Flair espresso machine. More particularly, tray 73 is inserted through slot passageway 71 through the side of inventive accessory 14, thus dispensing with the need for a specially fitted tray to be provided with the inventive apparatus.

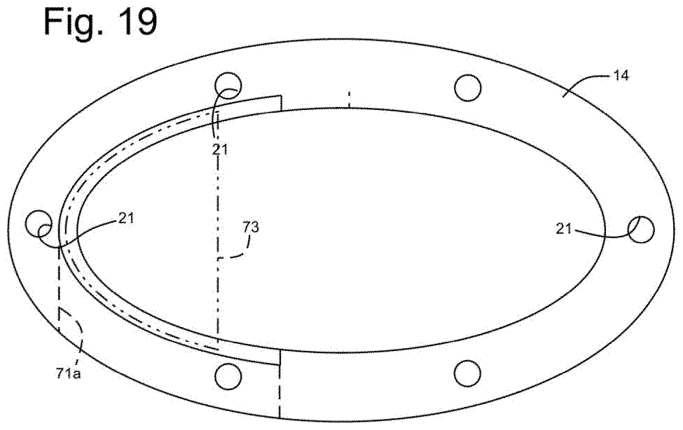

Still yet another alternative for the structure of the present invention similar to the above slot passageway is illustrated in FIG. 19. In accordance with this embodiment, a slot passageway 71a is provided at the brewing side for receiving a tray 73. In particular, it is noted that the size of the slot passageway is substantially longer than the length of tray 73. This is to accommodate the insertion of the tray provided with the Flair espresso machine. More particularly, tray 73 is inserted through slot passageway 71a through the side of inventive accessory 14, thus dispensing with the need for a specially fitted tray to be provided with the inventive apparatus.

Another alternative is illustrated in FIG. 16, in which feet 86 of the Flair machine are removed and replaced by pins 86a which fit in holes with a matching diameter in inventive accessory 14.

While illustrative embodiments of the invention have been described, it is noted that various modifications will be apparent to those of ordinary skill in the art in view of the above description and drawings. Such modifications are within the scope of the invention which is limited and defined only by the following claims.

What is claimed:

1. An accessory for an espresso coffee machine, wherein the espresso coffee machine has a bottom surface, said accessory comprising:
(a) a left support portion having a left support portion rear end and a left support portion forward end;
(b) a right support portion having a right support portion rear end and a right support portion forward end;
(c) a rear joining portion joining said left support portion rear end to said right support portion rear end,
wherein said rear joining portion, said left support portion and said right support portion are configured and dimensioned to define a space between said left support portion and said right support portion, and
wherein said left support portion, said right support portion and said rear joining portion together form a unitary accessory body, said accessory body having a top surface, said top surface mating with the bottom surface of said espresso machine to form a stable assembly therewith.

2. An accessory as in claim 1, wherein said unitary accessory body has a height which ranges between 10 millimeters and 100 millimeters.

3. An accessory as in claim 1, wherein said top surface is configured as a groove.

4. An accessory as in claim 1, wherein said top surface has a number of indentations for receiving feet secured to and forming a part of the bottom of said espresso coffee machine bottom surface.

5. An accessory as in claim 1, wherein said unitary body defines facing shoulder portions defined proximate said rear ends of said right and left support portions and within facing portions of said left support portion rear end and said right support portion rear end, and further comprising a tray configured to rest upon said facing forward shoulder portions, one of said rear ends of said right or left support portions defining a channel for insertion of said tray.

6. An accessory as in claim 1, wherein said unitary body defines rear facing shoulder portions defined within facing portions of said left support portion rear end and said right support portion rear end, and further comprising a rear tray configured to rest upon said facing rear shoulder portions.

7. An accessory as in claim 6, wherein said unitary body defines forward facing shoulder portions defined within facing portions of said left support portion forward end and said right support portion forward end, and further comprising a forward tray configured to rest upon said facing forward shoulder portions.

8. An accessory as in claim 7, wherein said forward tray and said rear tray both mate with said rear facing shoulder portions and said forward facing shoulder portions.

9. An accessory as in claim 1, wherein a substantially planar member is secured to the bottom of said unitary body, said substantially planar member having a relatively high coefficient of friction.

10. An accessory as in claim 9, further comprising at least one abutment member mounted for movement between a first position where said abutment member is contained within said unitary body and a second position where said abutment member extends from said unitary body.

11. An accessory as in claim 1, further comprising at least one abutment member mounted for movement between a first position where said abutment member is contained within said unitary body and a second position where said abutment member extends from said unitary body.

12. An accessory as in claim 1, wherein the espresso machine has a face with an inner periphery, and wherein at least one dimension of the inner periphery of the base of the unitary body is substantially smaller than the inner periphery of the base of the espresso coffee machine, whereby the shoulder may be defined by said inner periphery of the unitary body with the shoulder being substantially unblocked by the base of the espresso machine.

13. A system for pulling espresso shots, comprising:
(a) an espresso coffee machine of the type comprising a manually operated piston driving a quantity of water through ground coffee contained within a portafilter, said espresso coffee machine including a base with space defined between opposite sides of said base;
(b) a left support portion having a left support portion rear end and a left support portion forward end;
(c) a right support portion having a right support portion rear end and a right support portion forward end;
(d) a rear joining portion joining said left support portion rear end to said right support portion rear end,
wherein said rear joining portion, said left support portion and said right support portion are configured and dimensioned to define a space between said left support portion and said right support portion, and
wherein said left support portion, said right support portion and said rear joining portion together form a unitary accessory body, said accessory body having a top surfa63e, said top surface mating with the bottom surface of said espresso machine to form a stable assembly therewith.

14. An accessory as in claim 13, wherein said unitary accessory body has a height which ranges between 10 millimeters and 30 millimeters.

15. An accessory as in claim 13, wherein said top surface is configured as a groove.

16. An accessory as in claim 13, wherein said top surface has a number of indentations for receiving feet secured to and forming a part of the bottom of said espresso coffee machine bottom surface.

17. An accessory as in claim 13, wherein said unitary body defines forward facing shoulder portions defined within facing portions of said left support portion forward end and said right support portion forward end, and further comprising a tray configured to rest upon said facing forward shoulder portions.

18. An accessory as in claim 7, wherein said forward tray and said rear tray both mate with said rear facing shoulder portions and said forward facing shoulder portions.

19. An accessory as in claim 13, wherein a substantially planar member is secured to the bottom of said unitary body, said substantially planar member having a relatively high coefficient of friction.

20. An accessory as in claim 13, wherein the espresso machine has a face with an inner periphery, and wherein at least one dimension of the inner periphery of the base of the unitary body is substantially smaller than the inner periphery of the base of the espresso coffee machine, whereby the shoulder may be defined by said inner periphery of the unitary body with the shoulder being substantially unblocked by the base of the espresso machine.
